(19) United States
(12) Patent Application Publication
(10) Pub. No.: US 2024/0292147 A1
(43) Pub. Date: Aug. 29, 2024

(54) Directional Audio Transmission to Broadcast Devices

(71) Applicant: Telefonaktiebolaget LM Ericsson (publ), Stockholm (SE)

(72) Inventors: Andreas Kristensson, Södra Sandby (SE); Magnus Olsson, Klagshamn (SE); Dmitry Knyaginin, Göteborg (SE)

(21) Appl. No.: 18/692,413

(22) PCT Filed: Sep. 15, 2021
(86) PCT No.: PCT/EP2021/075289

§ 371 Date: Mar. 15, 2024

(51) Int. Cl. H04R 1/32

(52) U.S. Cl. CPC H04R 1/323

(57) ABSTRACT

There is provided mechanisms for directional audio transmission to at least one broadcast device. A method is performed by a control device. The method comprises obtaining an indication that an audio message as uttered by a user is recorded and is to be transmitted to at least one broadcast device. The method comprises estimating in which spatial direction the user uttered the audio message. The method comprises selecting, as a function of the estimated spatial direction, a set of broadcast devices for playing out the audio message. The method comprises initiating transmission of the audio message to the selected set of broadcast devices. The control device thereby performing the directional audio transmission to the at least one broadcast device.

### TECHNICAL FIELD

Embodiments presented herein relate to a method, a control device, a computer program, and a computer program product for directional audio transmission to at least one broadcast device.

### BACKGROUND

In general terms, an intelligent virtual assistant (IVA) or intelligent personal assistant (IPA) can be provided as a software agent that is configured to perform tasks or services for a human user based on commands or questions. The term chatbot is sometimes used to refer to virtual assistants generally or specifically accessed by online chat but will not be referred to in the rest of this disclosure. Users can ask their IVA or IPA questions, control home automation devices and media playback via voice, and manage other basic tasks such as email, to-do lists, and calendars with verbal commands.

Further in this respect, a smart speaker is a type of speaker and voice command device with an IVA or IPA that is configured for interactive actions and hands-free activation with the help of one so-called “hot word” (or several “hot words”). Some smart speakers can also act as a smart device that utilizes Wi-Fi.

Bluetooth and other wireless protocol standards to extend usage beyond audio playback, such as to control home automation devices. This can include, but is not limited to, features such as compatibility across a number of services and platforms, peer-to-peer connection through mesh networking, virtual assistants, and others. Each smart speaker can have its own designated interface and features in-house, usually launched or controlled via application or home automation software. Some smart speakers also include a screen to show the user a visual response. Smart speakers will hereinafter be referred to as broadcast devices.

A smart home hub, sometimes referred to as a smart hub, gateway, bridge, controller, or coordinator, is the control center for a smart home, and enables the components of the smart home to communicate and respond to each other via communication through a central point. The smart home hub can consist of dedicated hardware and/or software, and makes it possible to gather configuration, automation and monitoring of a smart house. A smart home can contain one, several, or even no smart home hubs. When using several smart home hubs it is sometimes possible to connect them to each other. Some smart home hubs support a wider selection of components, while others are more specialized for controlling products within certain product groups or using certain wireless technologies. A broadcast device with an IVA or IPA can often be used for speech input to a smart home hub.

In some smart home implementations, a user is enabled to broadcast an audio message to one or more broadcast devices in the home. It might even be possible for the user to broadcast an audio message to a broadcast device in a specific room in the house. This is made possible by the user explicitly specifying in which room the audio message is to be broadcast. For example, after having activated the IVA or IPA by uttering the “hot word” the user can, via further uttering, specify that he/she wishes to broadcast an audio message, then, via yet further uttering, specify in which room the audio message is to be broadcast, and then utter the audio message itself. This process requires the user to specify many pieces of information. Each piece of information must be interpreted by a natural language processing (NLP) entity to match user voice input to executable commands.

The pure number of pieces of information that the NLP entity needs to interpret puts a computational burden on the smart home system. Further, although the NLP entity might be configured for continuous learning. e.g., using artificial intelligence techniques, such as machine learning, there is still a risk that the NLP entity makes an erroneous interpretation of the voice input, and hence that the audio message is broadcast in the wrong room.

### SUMMARY

An object of embodiments herein is to address the above issues and drawbacks.

According to a first aspect the above issues and drawbacks are addressed by a method for directional audio transmission to at least one broadcast device. The method is performed by a control device. The method comprises obtaining an indication that an audio message as uttered by a user is recorded and is to be transmitted to at least one broadcast device. The method comprises estimating in which spatial direction the user uttered the audio message. The method comprises selecting, as a function of the estimated spatial direction, a set of broadcast devices for playing out the audio message. The method comprises initiating transmission of the audio message to the selected set of broadcast devices. The control device thereby performing the directional audio transmission to the at least one broadcast device.

According to a second aspect the above issues and drawbacks are addressed by a control device for directional audio transmission to at least one broadcast device. The control device comprises processing circuitry. The processing circuitry is configured to cause the control device to obtain an indication that an audio message as uttered by a user is recorded and is to be transmitted to at least one broadcast device. The processing circuitry is configured to cause the control device to estimate in which spatial direction the user uttered the audio message. The processing circuitry is configured to cause the control device to select, as a function of the estimated spatial direction, a set of broadcast devices for playing out the audio message. The processing circuitry is configured to cause the control device to initiate transmission of the audio message to the selected set of broadcast devices. The control device is thereby configured to perform the directional audio transmission to the at least one broadcast device.

According to a third aspect the above issues and drawbacks are addressed by a control device for directional audio transmission to at least one broadcast device. The control device comprises an obtain module configured to obtain an indication that an audio message as uttered by a user is recorded and is to be transmitted to at least one broadcast device. The control device comprises an estimate module configured to estimate in which spatial direction the user uttered the audio message. The control device comprises a select module configured to select, as a function of the estimated spatial direction, a set of broadcast devices for playing out the audio message. The control device comprises an initiate module configured to initiate transmission of the audio message to the selected set of broadcast devices. The control device is thereby configured to the directional audio transmission to the at least one broadcast device.

According to a fourth aspect the above issues and drawbacks are addressed by a computer program for directional audio transmission to at least one broadcast device, the computer program comprising computer program code which, when run on a control device, causes the control device to perform a method according to the first aspect.

According to a fifth aspect the above issues and drawbacks are addressed by a computer program product comprising a computer program according to the fourth aspect and a computer readable storage medium on which the computer program is stored. The computer readable storage medium could be a non-transitory computer readable storage medium.

Advantageously, these aspects simplify the process of broadcasting an audio message using a smart home system.

Advantageously, these aspects lessen the burden on the NLP entity since the number of pieces of information that needs to be interpreted is reduced.

Advantageously, these aspects reduce the number of broadcast devices the audio message is transmitted to.

Advantageously, these aspects simplify the process of broadcasting an audio message to a well-defined set of broadcast devices in a specific spatial direction, without the user having to explicitly specifying which broadcast devices (or even which room) the audio message is intended for.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 schematically illustrates a system according to an embodiment:

FIGS. 2, 5, and 6 are flowcharts of methods according to embodiments:

FIG. 3 schematically illustrates a floorplan of a building according to an embodiment:

FIG. 4 schematically illustrates a cross-sectional view of a building according to an embodiment:

FIG. 7 is a schematic diagram showing functional units of a control device according to an embodiment:

FIG. 8 is a schematic diagram showing functional modules of a control device according to an embodiment; and

FIG. 9 shows one example of a computer program product comprising computer readable storage medium according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein: rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

The embodiments disclosed herein relate to mechanisms for directional audio transmission to at least one broadcast device 140. In order to obtain such mechanisms there is provided a control device 200, a method performed by the control device 200, a computer program product comprising code, for example in the form of a computer program, that when run on a control device 200, causes the control device 200 to perform the method. At least some of the herein disclosed embodiments are based on using knowledge about user pose and/or pose estimation in spatial relation to available broadcast devices at time of transmission of an audio message and uses this knowledge to select a set of broadcast devices to play out the audio message.

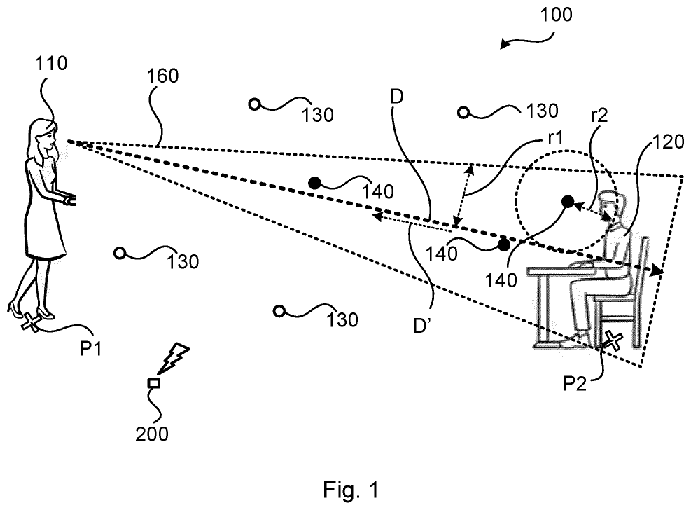

FIG. 1 schematically illustrates a system 100. The system comprises broadcast devices 130, 140 and a control device 200. It is assumed that the control device 200 is capable of communicating, according to one or more communication protocols, with the broadcast devices 130, 140, and similarly that each of the broadcast devices 130, 140 is capable of communicating, according to one or more communication protocols, with the control device 200. The broadcast devices 130, 140 are capable of receiving and playing out audio (or other media) messages. The broadcast devices 130, 140 could be provided as smart speakers. At least one of the broadcast devices 130, 140 could further implement the functionality of a smart home hub and/or an IVA or IPA. The control device 200 could be provided as a smart home hub and/or an IVA or IPA. With further reference to FIG. 1, it is assumed that a first user 110 located at a first spatial position P1 intends to communicate, by transmitting an audio message, to a second user 120 located at a second spatial position P2. It is thus assumed that the first user 110 is carrying, or that the system 100 otherwise comprises, an entity capable of recording utterances of the first user 110. This entity might be a separate device, such as a user equipment in communication with the control device 200, or at least one of the broadcast devices 130, 140, or the control device 200 itself. The second user 120 is in a spatial direction D with respect to the first user 110. Conversely, the first user 110 is in a spatial direction D′ with respect to the second user 120. Thus, the spatial direction D′ is the reverse spatial direction with respect to the spatial direction D. The control device 200 is capable of estimating in which spatial direction D the first user 110 intends to transmit audio messages and of selecting a suitable set of broadcast devices 140 for playing out the audio message. Further aspects of how the control device 200 might estimate the spatial direction D will be provided below. Further, a virtual spatial cone 160, with its apex at the first user 110, is illustrated along the direction D, where the radius of the virtual spatial cone 160 is represented by a first threshold distance r1. That is, the value of the first threshold distance r1 is a function of the distance, along the direction D, from the first user 110; the further away from the first user 110 along the spatial direction D, the larger the value of the first threshold distance r1. Broadcast devices 140 located within the virtual spatial cone 160 are illustrated with a black solid filling whilst broadcast devices 130 located outside the virtual spatial cone 160 are illustrated with a white solid filling. In the illustrated example of FIG. 1, the set of broadcast devices 140 selected by the control device 200 for playing out the audio message is defined by the broadcast devices 140 located within the virtual spatial cone 160. Further, for illustrative purposes, a circle having its center at one of the broadcast devices 140 is illustrated with a radius represented by a second threshold distance r2. It can be noted that the second user 120 (and more particularly at the head of the second user 120) is located within the circle. It is here noted that such a circle could be illustrated for each of the broadcast devices 130, 140.

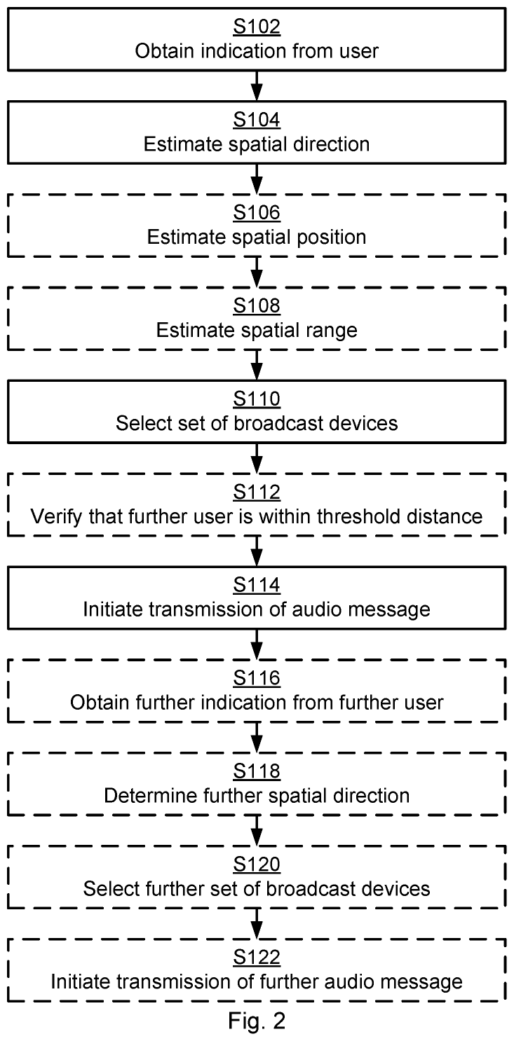

FIG. 2 is a flowchart illustrating embodiments of methods for directional audio transmission to at least one broadcast device 140. The methods are performed by the control device 200. The methods are advantageously provided as computer programs 920. Transmission of an audio message as uttered by the user 110 is initiated to a set of broadcast devices 140 as estimated based on the spatial direction D of the user 110.

It is assumed that the user 110 elects to broadcast an audio message and that the control device 200 obtains an indication of this, as in step S102.

S102: The control device 200 obtains an indication that an audio message as uttered by a user 110 is recorded and is to be transmitted to at least one broadcast device 140.

In this respect, it could either be that the audio message is to be transmitted directly, or that the user 110 is recording an audio message (possibly at least partly buffering the audio message) to be transmitted at a later point in time.

The control device 200 then estimates in which spatial direction D the user 110 is facing when uttering the audio message, as in step S104.

S104: The control device 200 estimates in which spatial direction D the user 110 uttered the audio message.

The control device 200 deduces which broadcast devices 140 that are capable of broadcasting the audio message in the intended direction, as in step S110.

S110: The control device 200 selects, as a function of the estimated spatial direction D, a set of broadcast devices 140 for playing out the audio message.

The control device 200 initiates transmission of the audio message to the relevant broadcast devices 140, as in step S114.

S114: The control device 200 initiates transmission of the audio message to the selected set of broadcast devices 140. The control device 200 thereby performs the directional audio transmission to the at least one selected broadcast device 140.

Embodiments relating to further details of directional audio transmission to at least one selected broadcast device 140 as performed by the control device 200 will now be disclosed.

The set of broadcast devices 140 might be selected from a set of available broadcast devices 130, 140, 150. In some aspects, the broadcast devices 140 positioned along, or close to, the spatial direction D are selected. Those of the available broadcast devices 130, 140, 150 that are located along the spatial direction D, or at least within a first threshold distance r1 from the spatial direction D might thus be selected.

There could be different ways for the control device 200 to estimate in which spatial direction D the user 110 uttered the audio message, as in S104. The spatial direction D might be estimated using any of: radio signalling, radar signalling, sound analysis, image analysis, or any combination thereof.

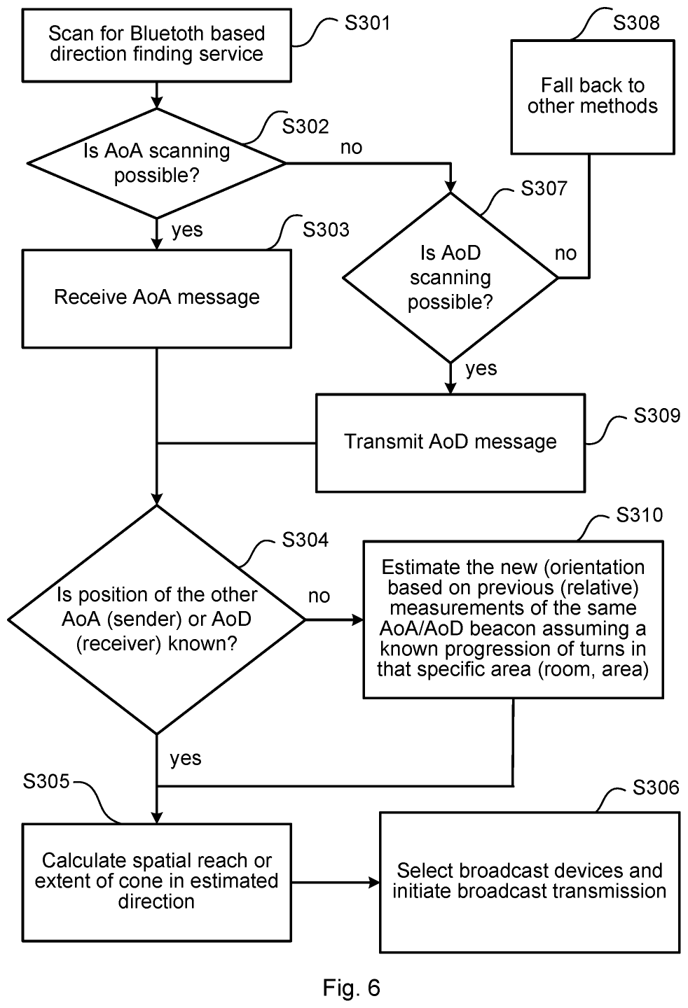

In some examples, the radio signalling involves using a Bluetooth based Direction Finding Service according to which either angle-of-arrival or angle-of-departure with respect to the user 110 is estimated as part of estimating the spatial direction D. Further aspects of using a Bluetooth based Direction Finding Service as part of estimating the spatial direction D will be disclosed in further detail below with reference to the flowchart of FIG. 6.

In some examples, the radar signalling involves, from a radar device, transmitting a radar signal that is reflected by the user 110, and from the reflected radar signal as received by the radar device estimating the spatial direction D of the user 110. In some examples, the sound analysis involves, at a sound recording and analyzing device, recording and analyzing sound waves resulting from utterance made by the user 110, and from the analysis (e.g., based on the angle-of-arrival of the sound waves at the sound recording and analyzing device) estimating the spatial direction D of the user 110. In some examples, the image analysis involves, at an image capturing unit, capturing and analyzing digital images of the user 110 and from the analysis (e.g., based on facial recognition, or the like) estimating the spatial direction D of the user 110.

In some aspects, the spatial direction D is defined by the pose of the user 110. Estimating the spatial direction D in S104 might then involve estimating the pose of the user 110.

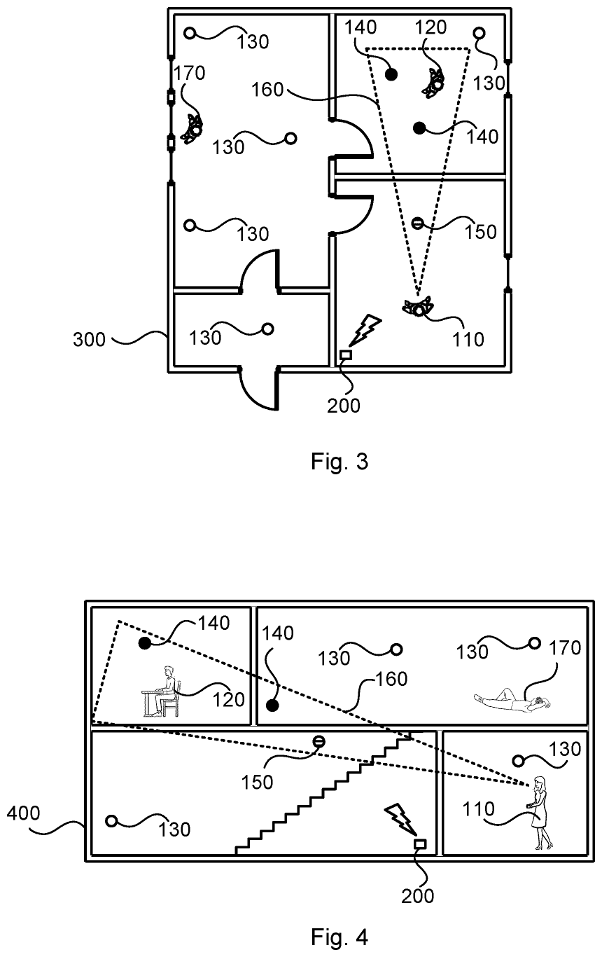

In some aspects, the broadcast devices 140 have locations specified according to building layout information, such as a floorplan 300 of a building, wherein the layout information 300, 400 further specifies constructional elements. The set of broadcast devices 140 might then further be selected depending on placement of the constructional elements. Examples of constructional elements are floors, ceilings, walls, windows, doors, and furniture. Further aspects of this will be disclosed below with reference to FIG. 3 and FIG. 4.

In some aspects, the set of broadcast devices 140 is selected also as a function of the spatial position P1 of the user 110. Therefore, in some embodiments, the control device 200 is configured to perform (optional) step S106:

S106: The control device 200 estimates at which spatial position P1 the user 110 is located when intending to transmit the audio message. The set of broadcast devices 140 is selected also as a function of the estimated spatial position P1. The spatial position P1 of the user 110 might be estimated in relation to locations of the set of available broadcast devices 130, 140, 150.

In some aspects, not all broadcast devices 140 located along the spatial direction D, or at least within the first threshold distance r1 from the spatial direction D might thus be selected. The number of broadcast devices 140 that are selected to play out the audio message could thus be further limited. Examples of how to achieve this will be disclosed next.

In some aspects, the spatial reach of the transmission is estimated so as to, together with the estimated spatial direction D, define a range in which audio message is to be played out. Hence, in some embodiments, the control device 200 is configured to perform (optional) step S108:

S108: The control device 200 estimates a spatial range in which the audio message is to be played out. The set of broadcast devices 140 is then further selected as a function of the estimated spatial range. This could further limit the number of broadcast devices 140 that are selected to play out the audio message.

In some aspects, when both the spatial position P1 of the user 110 and the spatial position P2 of the user 120 are known, the spatial range can be determined directly from the relation between these two spatial positions (in order to further limit the number of broadcast devices 140 that are selected to play out the audio message). In this respect, the location for each of the users 110, 120 can be estimated, tracked, or determined, in the same way as disclosed above for user 110.

In some aspects, user input from the user 110 identifies one of the broadcast devices 140 in the set of broadcast devices 140, and the broadcast device identified by the user input is, at least by the control device 200, assumed to be spatially closest to the user 110 of all broadcast devices 140 in the set of broadcast devices 140. The identified broadcast devices 140 is still assumed to be located along the spatial direction D. or at least within the first threshold distance r1 from the spatial direction D. The audio message is then not transmitted to any broadcast devices 140 located closer to the user 110 than the identified broadcast device 140. This could further limit the number of broadcast devices 140 that are selected to play out the audio message. The user 110 might thus select the closest broadcast device 140 in the spatial direction D. and the audio message is then sent to all the broadcast devices in the spatial direction D starting from the identified closest broadcast device 140. This can be used to skip some broadcast devices 140 that are close to the user 110 in the spatial direction D.

When the first threshold distance r1 from the spatial direction D increases as distance along the spatial direction D to the user 110 increases, a virtual spatial cone 160 is formed. The virtual spatial cone 160 has a radius defined by the first threshold distance r1. All broadcast devices 140 located within the virtual spatial cone 160 might then be selected to play out the audio message. There could be different extents to which the radius increases as distance along the spatial direction D to the user 110 increases. In some aspects, the radius increases only by a fraction from one end to the other, thus creating a virtual spatial cylinder instead of a virtual spatial cone 160. Further in this respect, the spatial position P1 of the user 110 can affect the shape of the virtual spatial cone 160. That is, user input can be used to determine a fixed value of the radius and/or how much the radius is to increase as distance along the spatial direction D to the user 110 increases. In some aspects user input from the user 110 thus affects how many broadcast devices 140 are selected for playing out the audio message. For example, user gestures, such as the user 110 forming a cone with his/her hands around the mouth, might affect the appearance of the virtual spatial cone 160 can be changed between the user 110 forming a comparatively small cone with the hands around the mouth or a comparatively big cone with the hands around the mouth. Such a cone formed around the mouth of the user 110 can be detected by image processing. Thus, an image capturing unit (such as a digital camera) might be arranged and configured to capture digital images of the user 110 and to analyze the captured digital images so as to identify gestures made by the user. There could also be other ways to identify the user input, such as by means of voice commands, or other types of gestures than forming a cone around the mouth. The value of the first threshold distance r1 could thus be affected by the user input. Hence, user input from the user 110 might define the first threshold distance r1. In other words, user gestures might affect the shape of the virtual spatial cone 160.

In some aspects, a given broadcast device 140, located within the virtual spatial cone 160, will only play out the audio message if there is presence by a further user 120 nearby the given broadcast device 140. It might thus be verified that another user 120 is in vicinity of the selected broadcast devices 140 before playing out the audio message to these broadcast devices 140. In particularly, in some embodiments, the control device 200 is configured to perform (optional) step S112:

S112: The control device 200 verifies that at least one of the broadcast devices 140 in the set of broadcast devices 140 is within a second threshold distance r2 from a further user 120 intended to receive the audio message before initiating transmission of the audio message to the selected set of broadcast devices 140.

Presence of the further user 120 within the second threshold distance r2 might be verified by the broadcast devices 140 by the same means as used for estimating the spatial direction of the user 110, e.g., radio signalling, radar signalling, sound analysis, image analysis, or any combination thereof.

In some aspects, more broadcast devices 140 are selected if no further user 120 is in the vicinity of the initially selected broadcast devices 140. That is, when at least one of the broadcast devices 140 in the set of broadcast devices 140 is not within the second threshold distance r2 from the further user 120, the set of broadcast devices 140 might be modified until at least one of the broadcast devices 140 in the set of broadcast devices 140 is within the second threshold distance r2 from the further user 120.

Hence, the virtual spatial cone 160 might be modified in size (e.g., expanded) if no broadcast devices 140 are found in a first broadcast attempt and a new attempt is made to broadcast the audio message with a virtual spatial cone 160 having a modified size. It could also be that no response is given to the first broadcast attempt and/or that none of the selected broadcast devices 140 register, or detect, human presence. Then a second broadcast attempt could allow for an expanded virtual spatial cone 160 so as to find further broadcast devices that reach the targeted user 120 or audience. Further, with respect to S108, with a known distance between the user 110 and the further user 120, the virtual spatial cone 160 can also be reduced in length to target a minimum distance to the start of the broadcast and a maximum distance for the broadcast of the audio message. This allows for that no audio message is broadcasted outside the range of the given virtual spatial cone 160 (at that instance).

Intermediate reference is here made to FIG. 3 and FIG. 4.

FIG. 3 shows an example floorplan 300 of a building. Locations of broadcast devices 130, 140 with respect to the floorplan 300 are also shown. It is assumed that user 110 intends to transmit an audio message towards user 120. User 170 does not need to receive the audio message. In the illustrative example of FIG. 3, the users 110, 120, 170 are not in the same room. According to herein disclosed embodiments, broadcast devices 140, 150 within a virtual spatial cone 160 are selected for playing out the audio message. However, since, according to the floorplan 300, broadcast device 150 is located within the same room as the user 110 it can be excluded from the set of selected broadcast devices.

FIG. 4 shows an example cross-sectional view 400 of a building. Locations of broadcast devices 130, 140 with respect to the building are also shown. It is assumed that user 110 intends to transmit an audio message towards user 120. User 170 does not need to receive the audio message. In the illustrative example of FIG. 4, the users 110, 120, 170 are neither in the same room, nor on the same floor. However, assuming that there is information indicating, as e.g. available from a sensor, that there is not any user within a certain distance from broadcast device 150, it can be excluded from the set of selected broadcast devices.

In some aspects, a respondent, defined by the further user 120, answering to a directional broadcast as initiated by the user 110 automatically creates a directional broadcast but in reverse direction towards the user 110. Pose, or any other direction identifying information, is thus not required for the further user 120.

Hence, assuming that there is a reverse spatial direction D′ to the spatial direction D, in some embodiments the control device 200 is configured to perform (optional) steps S116 to S122:

S116: The control device 200 obtains an indication that a further user 120 intended to receive the audio message intends to transmit a further audio message that is in response to the audio message.

S118: The control device 200 determines the further spatial direction in which the further audio message is to be transmitted as the reverse spatial direction D′ to the spatial direction D.

S120: The control device 200 selects, as a function of the reverse spatial direction D′, a further set of broadcast devices for playing out the further audio message.

S122: The control device 200 initiates transmission of the further audio message to the selected further set of broadcast devices.

In some aspects, the control device 200 initiates transmission of the further audio message to the selected further set of broadcast devices only in case a timer has not expired. The timer starts when transmission of the (original) audio message is initiated. This is to ensure that the user 110 has not left the position P1 when transmission of the further audio message is initiated.

In some embodiments, the control device 200 initiates transmission of the further audio message to broadcast devices located along, or close to, the reverse spatial direction D′. In some embodiments, the control device 200 initiates transmission of the further audio message only to the broadcast device that originally recorded, or captured, the audio message of the user 110. Hence, these two embodiments might avoid S118-S122 to be performed.

Those of the available broadcast devices that are located along the reverse spatial direction D′, or at least within a third threshold distance from the reverse spatial direction D′ might be selected.

In some aspects, selection of the further set of broadcast devices creates a further virtual spatial cone inside which the further audio message is played out. That is, when the third threshold distance from the reverse spatial direction D′ increases as distance along the reverse spatial direction D′ to the further user 120 increases, a further virtual spatial cone is formed. The further virtual spatial cone has a radius defined by the third threshold distance. All broadcast devices 140 located within the further virtual spatial cone might then be selected to play out the further audio message.

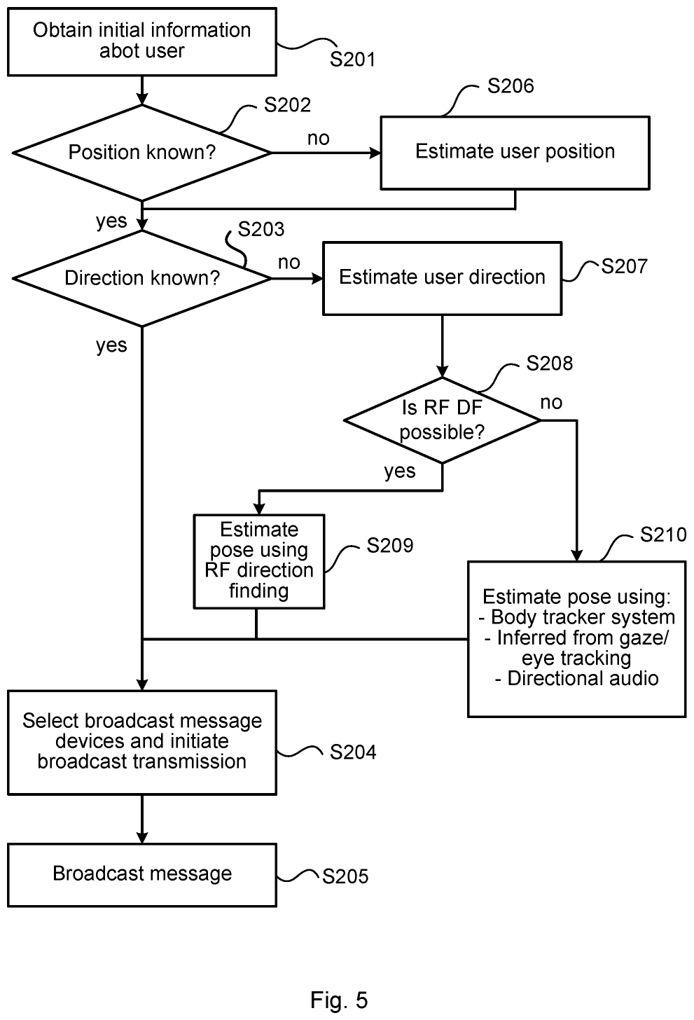

One particular embodiment for estimating the spatial direction and the spatial position of the user will now be disclosed with reference to the flowchart of FIG. 5. In more detail, the procedure in the flowchart specifies how to determine user position and user head pose, where the head pose represent the typical spatial direction in which the user is facing when uttering the audio message to be transmitted. The procedure in FIG. 5 is performed by the control device.

S201: Initial information about the user is obtained.

S202: It is determined if the spatial position of the user can be determined from the available information. If yes, step S203 is entered and else step S206 is entered.

S203: It is determined if the spatial direction in which the user intends to transmit the audio message can be determined from the available information. If yes, step S204 is entered and else step S207 is entered.

S204: A set of broadcast devices is selected for playing out the audio message as a function of the spatial position and the spatial direction.

S205: Transmission of the audio message to the selected set of broadcast devices is initiated.

S206: Further information usable for estimating the spatial position of the user is obtained. The further information could be obtained from different types of sources, such as from global navigation satellite system (GNSS) data, wide area network (WAN) data, or Bluetooth data).

S207: The spatial direction in which the user intends to transmit the audio message is estimated from an estimation of the user pose or inferred from an estimation of the body orientation of the user, possible using the techniques described in step S209 or step S210.

S208: It is checked whether any radio frequency based (RF) direction finding (DF) technique, such as such as Bluetooth direction finding (BT-DF), is available for estimating the spatial direction in which the user intends to transmit the audio message. If yes, step S209 is entered and else step S210 is entered.

S209: The spatial direction in which the user intends to transmit the audio message is estimated using RF DF.

S210: The user pose is estimated from any of: a body tracker system (such as a head sensor) of the user, gaze and/or eye tracking of the user, directional audio estimation of the user to deduce the direction of speech (in case of an audible message is being recorded or produced). The estimated user pose then defines the estimate of the spatial direction in which the user intends to transmit the audio message.

One particular embodiment for using BT-DF to estimate the spatial direction of the user will now be disclosed with reference to the flowchart of FIG. 6. The BT-DF involves the use of a user device, as worn by the first user, and a so-called anchor device.

S301: A scan is at the user device made for any anchor device transmitting a Constant Tone Extension (CTE) message.

S302: It is checked at the user device if any Angle of Arrival (AoA) estimation technique is available. If yes step S303 is entered and else step S307 is entered.

S303: A signal carrying the CTE messages is transmitted by the anchor device and received and measured on by the user device.

S304: It is checked at the user device if the position of the anchor device is known. If yes step S305 is entered and else step S310 is entered.

S305: A virtual spatial cone 160 is formed based on the estimated spatial direction D (as given by the head pose of the first user).

S306: A set of broadcast devices 140 is selected based on their ability to reach the intended second user (in the direction of the head pose of the first user).

S307: It is checked at the user device if any Angle of Departure (AoD) estimation technique is available. If yes step S309 is entered and else step S308 is entered.

S308: The user device falls back to other techniques for estimating the spatial direction in which the first user intends to transmit the audio message.

S309: The user device starts transmitting a CTE message. An end-point device, such as the anchor device, receives and measures on the signal carrying the CTE message. The end-point device then sends the measurements back to the user device.

S310: The spatial direction is estimated based on the AoA or AoD estimation technique (whichever is available in S302 or S307).

BT-DF is a collection of techniques that may implement the same method in a variety of ways depending on the placement of the antenna array in the sending role or receiving role. There are variants where the BT-DF is based on the use of connectionless means. In such a variant, a Bluetooth beacon with constant tone extension is used with the BT-DF receiver. There are variants where the BT-DF is based on the use of a connection-oriented technique. In such a variant, the device that has requested a direction finding operation is also able to communicate with the end-point responsible for the measurement of the signal to determine the direction finding results. Any of these variants can be used as part of the herein disclosed embodiments.

In some non-limiting examples, the control device 200 is part of, integrated with, or collocated with, at least one of: a piece of extended reality (XR) equipment (such as glasses or a headset), a user equipment (UE), one of the broadcast devices 120, 130, 140, a computational cloud server, an IVA or IPA, or a smart home hub. In some aspects, the control device 200 is preconfigured to as per default perform any method as herein disclosed. In other aspects the control device is configured to perform any method as herein disclosed upon having received user input to do so. In other words, the user 110 might select an option that the set of broadcast devices 140 to play out a given audio message is to be selected based on in which spatial direction D the user 110 utters the given audio message.

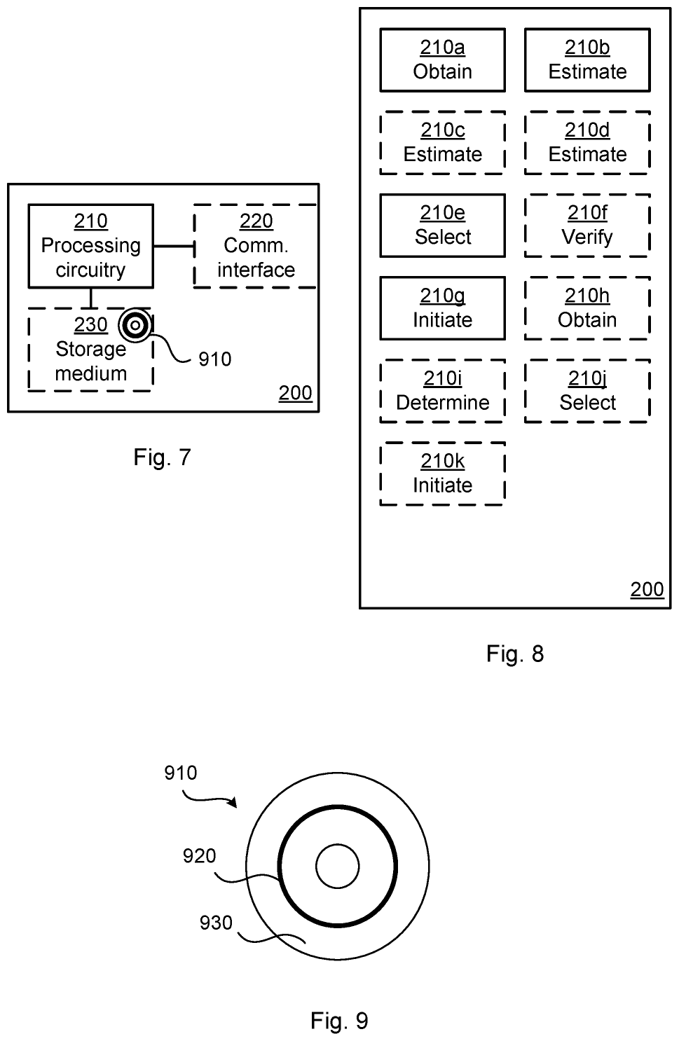

FIG. 7 schematically illustrates, in terms of a number of functional units, the components of a control device 200 according to an embodiment. Processing circuitry 210 is provided using any combination of one or more of a suitable central processing unit (CPU), multiprocessor, microcontroller, digital signal processor (DSP), etc. . . . capable of executing software instructions stored in a computer program product 910 (as in FIG. 9). e.g. in the form of a storage medium 230. The processing circuitry 210 may further be provided as at least one application specific integrated circuit (ASIC), or field programmable gate array (FPGA).

Particularly, the processing circuitry 210 is configured to cause the control device 200 to perform a set of operations, or steps, as disclosed above. For example, the storage medium 230 may store the set of operations, and the processing circuitry 210 may be configured to retrieve the set of operations from the storage medium 230 to cause the control device 200 to perform the set of operations. The set of operations may be provided as a set of executable instructions.

Thus the processing circuitry 210 is thereby arranged to execute methods as herein disclosed. The storage medium 230 may also comprise persistent storage, which, for example, can be any single one or combination of magnetic memory, optical memory, solid state memory or even remotely mounted memory. The control device 200 may further comprise a communications interface 220 at least configured for communications with other entities, functions, nodes, and devices, such as broadcast devices 130, 140, 150, user devices, etc., as required for performing any method disclosed herein. As such the communications interface 220 may comprise one or more transmitters and receivers, comprising analogue and digital components. The processing circuitry 210 controls the general operation of the control device 200 e.g. by sending data and control signals to the communications interface 220 and the storage medium 230, by receiving data and reports from the communications interface 220, and by retrieving data and instructions from the storage medium 230. Other components, as well as the related functionality, of the control device 200 are omitted in order not to obscure the concepts presented herein.

FIG. 8 schematically illustrates, in terms of a number of functional modules, the components of a control device 200 according to an embodiment. The control device 200 of FIG. 8 comprises a number of functional modules: an obtain module 210a configured to perform step S102, an estimate module 210b configured to perform step S104, a select module 210e configured to perform step S110, and an initiate module 210g configured to perform step S114. The control device 200 of FIG. 8 may further comprise a number of optional functional modules, such as any of an estimate module 210c configured to perform step S106, an estimate module 210d configured to perform step S108, a verify module 210f configured to perform step S112, an obtain module 210h configured to perform step S116, a determine module 210i configured to perform step S118, a select module 210j configured to perform step S120, and an initiate module 210k configured to perform step S122.

In general terms, each functional module 210a:210k may in one embodiment be implemented only in hardware and in another embodiment with the help of software. i.e., the latter embodiment having computer program instructions stored on the storage medium 230 which when run on the processing circuitry makes the control device 200 perform the corresponding steps mentioned above in conjunction with FIG. 8. It should also be mentioned that even though the modules correspond to parts of a computer program, they do not need to be separate modules therein, but the way in which they are implemented in software is dependent on the programming language used. Preferably, one or more or all functional modules 210a:210k may be implemented by the processing circuitry 210, possibly in cooperation with the communications interface 220 and/or the storage medium 230. The processing circuitry 210 may thus be configured to from the storage medium 230 fetch instructions as provided by a functional module 210a:210k and to execute these instructions, thereby performing any steps as disclosed herein.

The control device 200 may be provided as a standalone device or as a part of at least one further device. For example, the control device 200 may be provided in a node of a radio access network or in a node of a core network. Alternatively, functionality of the control device 200 may be distributed between at least two devices, or nodes. These at least two nodes, or devices, may either be part of the same network part (such as in a (radio) access network or a core network) or may be spread between at least two such network parts. Thus, a first portion of the instructions performed by the control device 200 may be executed in a first device, and a second portion of the of the instructions performed by the control device 200 may be executed in a second device: the herein disclosed embodiments are not limited to any particular number of devices on which the instructions performed by the control device 200 may be executed. Hence, the methods according to the herein disclosed embodiments are suitable to be performed by a control device 200 residing in a cloud computational environment. Therefore, although a single processing circuitry 210 is illustrated in FIG. 7 the processing circuitry 210 may be distributed among a plurality of devices, or nodes. The same applies to the functional modules 210a:210k of FIG. 8 and the computer program 920 of FIG. 9.

FIG. 9 shows one example of a computer program product 910 comprising computer readable storage medium 930. On this computer readable storage medium 930, a computer program 920 can be stored, which computer program 920 can cause the processing circuitry 210 and thereto operatively coupled entities and devices, such as the communications interface 220 and the storage medium 230, to execute methods according to embodiments described herein. The computer program 920 and/or computer program product 910 may thus provide means for performing any steps as herein disclosed.

In the example of FIG. 9, the computer program product 910 is illustrated as an optical disc, such as a CD (compact disc) or a DVD (digital versatile disc) or a Blu-Ray disc. The computer program product 910 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 920 is here schematically shown as a track on the depicted optical disk, the computer program 920 can be stored in any way which is suitable for the computer program product 910.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1-22. (canceled)

23. A method for directional audio transmission to at least one broadcast device, the method being performed by a control device, the method comprising:
obtaining an indication that an audio message as uttered by a user is recorded and is to be transmitted to at least one broadcast device;
estimating in which spatial direction the user uttered the audio message;
selecting, as a function of the estimated spatial direction, a set of broadcast devices for playing out the audio message; and
initiating transmission of the audio message to the selected set of broadcast devices, thereby performing the directional audio transmission to the at least one broadcast device.

24. The method of claim 23, wherein the set of broadcast devices is selected from a set of available broadcast devices, and wherein those of the available broadcast devices that are located along the spatial direction, or at least within a first threshold distance from the spatial direction are selected.

25. The method of claim 23, wherein the method further comprises:
estimating at which spatial position the user is located when intending to transmit the audio message, and wherein the set of broadcast devices is selected also as a function of the estimated spatial position.

26. The method of claim 25, wherein the set of broadcast devices is selected from a set of available broadcast devices, and wherein the spatial position of the user is estimated in relation to locations of the set of available broadcast devices.

27. The method of claim 23, wherein the spatial direction is estimated using any of: radio signalling, radar signalling, sound analysis, image analysis, or any combination thereof.

28. The method of claim 27, wherein the radio signalling involves using a Bluetooth-based Direction Finding Service of which either angle-of-arrival or angle-of-departure with respect to the user is estimated as part of estimating the spatial direction.

29. The method of claim 23, wherein the broadcast devices have locations specified of a floorplan, wherein the floorplan further specifies constructional elements, and wherein the set of broadcast devices further is selected depending on placement of the constructional elements.

30. The method of claim 23, wherein the method further comprises:
estimating a spatial range in which the audio message is to be played out, and wherein the set of broadcast devices further is selected as a function of the estimated spatial range.

31. The method of claim 23, wherein user input from the user identifies one of the broadcast devices in the set of broadcast devices, and wherein the broadcast device identified by the user input is spatially closest to the user of all broadcast devices in the set of broadcast devices.

32. The method of claim 24 wherein the first threshold distance from the spatial direction increases as distance along the spatial direction to the user increases, whereby a virtual spatial cone is formed having a radius defined by the first threshold distance, and wherein all broadcast devices located within the virtual spatial cone are selected to play out the audio message.

33. The method of claim 24, wherein user input from the user defines the first threshold distance.

34. The method of claim 23, wherein the method further comprises:
verifying that at least one of the broadcast devices in the set of broadcast devices is within a second threshold distance from a further user before initiating transmission of the audio message to the selected set of broadcast devices.

35. The method of claim 34, wherein, when at least one of the broadcast devices in the set of broadcast devices is not within the second threshold distance from the further user, the set of broadcast devices is modified until at least one of the broadcast devices in the set of broadcast devices is within the second threshold distance from the further user.

36. The method of claim 23, wherein there is a reverse spatial direction to the spatial direction, and wherein the method further comprises:
obtaining an indication that a further user intended to receive the audio message intends to transmit a further audio message that is in response to the audio message;
determining the further spatial direction in which the further audio message is to be transmitted as the reverse spatial direction to the spatial direction;
selecting, as a function of the reverse spatial direction, a further set of broadcast devices for playing out the further audio message; and
initiating transmission of the further audio message to the selected further set of broadcast devices.

37. The method of claim 36, wherein the further set of broadcast devices is selected from a set of available broadcast devices, and wherein those of the available broadcast devices that are located along the reverse spatial direction, or at least within a third threshold distance from the reverse spatial direction are selected.

38. The method of claim 37, wherein the third threshold distance from the reverse spatial direction increases as distance along the reverse spatial direction to the further user increases, whereby a further virtual spatial cone is formed having a radius defined by the third threshold distance, and wherein all broadcast devices located within the further virtual spatial cone are selected to play out the further audio message.

39. The method of claim 23, wherein the control device is part of, integrated with, or collocated with, at least one of: a piece of extended reality (XR) equipment, a user equipment, one of the broadcast devices, a computational cloud server.

40. A control device for directional audio transmission to at least one broadcast device, the control device comprising processing circuitry, the processing circuitry being configured to cause the control device to:
obtain an indication that an audio message as uttered by a user is recorded and is to be transmitted to at least one broadcast device;
estimate in which spatial direction the user uttered the audio message;
select, as a function of the estimated spatial direction, a set of broadcast devices for playing out the audio message; and
initiate transmission of the audio message to the selected set of broadcast devices, thereby performing the directional audio transmission to the at least one broadcast device.

41. A computer-readable medium comprising, stored thereupon, a computer program for directional audio transmission to at least one broadcast device, the computer program comprising computer code configured so that, when run on processing circuitry of a control device, the computer code causes the control device to:
obtain an indication that an audio message as uttered by a user is recorded and is to be transmitted to at least one broadcast device;
estimate in which spatial direction the user uttered the audio message;
select, as a function of the estimated spatial direction, a set of broadcast devices for playing out the audio message; and
initiate transmission of the audio message to the selected set of broadcast devices, thereby performing the directional audio transmission to the at least one broadcast device.
